(19) United States
(12) Patent Application Publication
(10) Pub. No.: US 2025/0132536 A1
(43) Pub. Date: Apr. 24, 2025

(54) CRIMPING DEVICE

(71) Applicant: HARTING ELECTRIC STIFTUNG & CO. KG, Espelkamp (DE)

(72) Inventors: Daniel WESSELER, Georgsmarienhütte (DE); Joachim KRÄMER, Kirchlengern (DE)

(21) Appl. No.: 18/913,497

(22) Filed: Oct. 11, 2024

(30) Foreign Application Priority Data
Oct. 20, 2023 (DE) 10 2023 128 920.9

(51) Int. Cl. H01R 43/048

(52) U.S. Cl. CPC H01R 43/0486

(57) ABSTRACT

A crimping device is provided for a conductor of a predefined cable to a predefined contact sleeve, having a crimp of a predefined crimp height, the crimping device has at least two suitable pressing elements that are mounted so as to be reversibly movable relative to a central crimping zone of the crimping device; for the proper operation of the pressing elements, the crimping device has a drive, the drive being operatively connected to the pressing elements via a mechanism; the drive being an electrically driven, substantially low-profile cylindrical coreless motor, and the pressing elements and the mechanism being arranged within the cylindrical motor. A controller for controlling the operation of the crimping device, a method for calibrating the crimping device, and a method for controlling the operation of the crimping device is also provided.

### BACKGROUND

### Technical Field

The present disclosure relates to a crimping device having a drive suitable for operating a crimping device, as well as to a controller suitable for operation and to a method for controlling a crimping device.

In crimping, two components are connected to one another by plastic deformation, by a forming tool, or by use of a pressing force. This results in a crimp, i.e., a mechanical connection between a conductor and a connection element such as, for example, a contact sleeve, that is not easily separable.

In production of the crimp, a high quality of crimp is desirable for a permanent mechanically and electrically stable connection between the crimped components, with a contact sleeve that is suitable for a predefined application and a predefined conductor being crimped to the conductor in each case.

### Description of the Related Art

A conventional crimping device suitable for stationary industrial operation is known, for example, from the document WO 2020/147888 A1, which relates to a method for monitoring the state of the crimping device and to an appliance suitable for executing the method. The known crimping device is an indent crimping device, the pressing elements of which are realized as mutually opposite tapered spikes. Setting of a suitable crimp height for a predefined contact sleeve and a predefined cable, namely the setting of a minimum distance between two mutually opposite spikes up to which the spikes are moved towards each other during crimping, is affected in a disadvantageously complex manner by use of adjusting spikes, by a suitable setting mechanism. In each case, an adjustable mechanical stop is set for a lever via which a pneumatic pressure device is operatively connected to the crimping device. The appliance comprising a pressure device, lever and crimping device requires a correspondingly disadvantageous large amount of space, and is disadvantageously heavy and is not suitable for a mobile hand-held tool.

Known from the document DE 10 2018 130 564 A1 is a crimping tool that has an advantageous lever, referred to as an indenter actuator cam arm, which is movable between an unactuated position and an actuated position in order to actuate four indenters for the purpose of crimping a terminal connection. The crimping tool includes a complex drive arrangement that is movable along a drive spindle between a retracted position and an advanced position. The drive arrangement, which has a correspondingly disadvantageously high space requirement, has a drive nut on the drive spindle, and has a coupling body that for operation is coupled between the drive nut and the indenter actuator cam arm. In order to set a desirably correct crimp height, a mechanical stop for the indenter actuator cam arm is provided, the setting of which stop is likewise disadvantageously complex.

### BRIEF SUMMARY

Embodiments of the present disclosure provide a reliable crimping device, of a compact structural form, that is suitable for many applications. A drive suitable for a crimping device as well as a method suitable for operating the crimping device, and a suitable controller.

The present disclosure relates to a crimping device for crimping a conductor of a predefined cable to a predefined contact sleeve. In order to provide a crimp of a predefined crimp height, the crimping device has at least two suitable pressing elements that are mounted so as to be reversibly movable relative to a central crimping zone of the crimping device. For the proper operation of the pressing elements, the crimping device has a suitable drive, which is operatively connected to the pressing elements via a suitable mechanism.

The drive is advantageously realized as an electrically driven, substantially low-profile cylindrical coreless motor, which allows the pressing elements and the mechanism to be arranged within the cylindrical motor, thereby making it possible to provide an advantageously compact crimping device that is suitable for many applications, such as for a crimping device of a stationary industrial appliance, and also for a crimping device of a mobile hand-held tool.

Coreless motors, and thus also the crimping device described herein, may be of an advantageously compact design, and have an outer diameter in the range of from 80 mm to 100 mm, and advantageously from 60 mm to 80 mm, and advantageously in the range of from 50 mm to 60 mm.

Coreless motors are also characterized by a very high torque combined with a small structural size, which is also advantageous for operation of a crimping device and, moreover, they allow a very dynamic and fast change of rotational speed, which is also advantageous for desirably precise setting, or controlling, of a predefined crimp height. A suitable coreless motor may be provided, such as by a stepper motor or a servo motor.

A mechanism that is suitable for operating a coreless motor and the crimping device may be realized as a gearing acting in combination with the motor and the pressing elements, and advantageously realized as a cycloidal gearing that is operatively connected to the motor and the crimping elements, in which case the central crimping zone and the pressing elements may advantageously be arranged within the gearing, and the gearing is arranged together with the central crimping zone and the crimping elements within the motor.

With this advantageous design and arrangement, the compact structural form of the crimping device described above is retained. Moreover, a cycloidal gearing allows an advantageous mechanical design and arrangement. The cycloidal gearing may be advantageously realized and arranged in such a way that the gearing generates a predefined transmission ratio i, of a rotational speed of the motor to the gearing operatively connected to the pressing elements, that is much greater than 1, such that there is generated by the mechanism a predefined reduction ratio i, which is advantageous for the operation of a crimping device, and thereby in addition an advantageous corresponding increase in a maximally transmissible torque, namely the output torque.

The gearing with its features described below may appropriately be realized in such a way that the reduction ratio i lies in a range of from 50 to 1,000, and advantageously in a range of from 60 to 600 and, for the application of the crimping device in a mobile hand-held tool, advantageously in the range of approximately i=100, and an advantageous output torque in the range of from 100 Nm to 400 Nm, and advantageously of approximately 200 Nm, is made possible.

For this purpose, the cycloidal gearing may appropriately have a cam disc and a spike controller for controlling the pressing elements, which are adjacent to each other and act in combination mechanically.

The cam disc in this case may have an outer contour that is realized and arranged to correspond to an inner contour of a rotor of the motor in such a way that a predefined rotation of the rotor can be transmitted to the cam disc. The cam disc may also appropriately have an inner contour having a cycloidal toothing that acts in combination with the spike controller.

When reference is made here and throughout the context of the application to the inner contour of the rotor, the cam disc and the spike controller, this refers in each case to the contour that faces towards the central crimping zone, while the outer contour opposite to the inner contour is in each case the contour that faces away from the crimping zone and towards the motor.

The spike controller appropriately has an outer contour, likewise having cycloidal toothing, which is realized and arranged to correspond to the inner contour of the cam disc in such a way that a predefined rotation of the cam disc can be transmitted to the spike controller. To drive the pressing elements, the spike controller for a gearing output has an inner contour realized as a control cam of the pressing elements, which is realized and arranged in such a way that a rotation of the spike controller by a predefined angle produces a predefined position of the pressing elements that is radially perpendicular to a central axis of a central crimping zone of the crimping device.

The control cam of the spike controller described above may appropriately be realized and arranged in such a way that an advantageous recalibration of the crimping device is rendered easily possible, including in the case of possible attrition of the gearing mechanism and/or of the pressing elements.

A crimping device described above may advantageously be realized as an indent crimping device having pressing elements realized in the manner of spikes, and advantageously as a 4-indent crimping device, the pressing elements of which are guided, radially perpendicularly with respect to the central axis of the central crimping zone, in a spike carrier arranged centrally within the motor.

In this case, a cycloidal gearing suitable for the operation of a 4-indent crimping device may appropriately be realized in such a way that a rotation of the spike controller by an angle of, obviously, less than 90°, as described below with reference to the accompanying drawings, and appropriately at least 20° and advantageously approximately 60°, causes a maximum deflection of the pressing elements from their rest position, or zero position, without any deflection.

A crimping device described above may also have a sensor system, suitable for operating the crimping device by a hardware- and software-supported controller, which comprises at least one sensor for angle measurement and/or torque measurement and/or force measurement and/or identification of a contact sleeve, and the controller may also be configured to regulate the rotational speed of the motor in accordance with the crimp height, such as in a pulsed manner. The controller may be suitably configured to ascertain the crimping force from the motor current consumption.

Suitable sensors mentioned above may be provided by, for example, suitably arranged Hall sensors, strain gauges and optical sensors.

Embodiments of the present disclosure also relate to a controller, described below, for operating a crimping device, and to a method for calibrating a crimping device and to a method for controlling the operation of a crimping device, which are also described below.

As mentioned above, the present disclosure also relates to a hardware- and software-supported controller for operating a crimping device, having an electric drive and a transmission ratio i of very much greater than 1, the advantages of which are described above in connection with the crimping device.

The controller is appropriately connected, in respect of signal and/or data transmission, to a suitable user operating device and/or display device and/or memory device, with first, second and third data being appropriately available on the memory device for the controller of the crimping device.

The first data appropriately include the exact transmission ratio i of the rotational speed of a rotor of the drive to a rotational speed of the gearing output, acting in combination with pressing elements of the crimping device, of a gearing acting in combination with the drive, and additionally the functional relationship of the angle of rotation of the drive and of the angle of rotation of the gearing output to a force acting upon on the pressing elements, as well as to the position of the pressing elements, such as during operation of the crimping device in idling mode, from the rest position, or zero position, of the pressing elements to the position of their maximum deflection.

The second data include, for a crimping of a contact sleeve to a conductor of a cable, data suitable for identifying the contact sleeve, and also technical properties and characteristics of in each case a multiplicity of different contact sleeves and in each case the outer diameter and the crimp height of an individual contact sleeve suitable for the crimping.

The third data includes the functional relationship of the angle of rotation of the drive and of the angle of rotation to a force acting upon the pressing elements during operation of the crimping device in idling mode, from the rest position, or zero position, of the pressing elements up to the position of their maximum deflection.

The controller is advantageously suitably configured, in crimping of a contact sleeve to a conductor of a cable, to set the crimp height by regulating the rotational speed of the drive corresponding to the crimp height, such as in a pulsed manner, in accordance with the first and the second data.

For the purpose of controlling and monitoring the operation of the crimping device, the controller is appropriately connected, in respect of signal and/or data transmission, to a sensor system of the crimping device that includes at least one sensor for angle measurement and/or torque measurement and/or force measurement and/or identification of a contact sleeve.

For its operation and for its use in the method, described below, for calibrating a crimping device and the method, likewise described below, for controlling the operation of a crimping device appropriately, the controller may additionally be appropriately connected, in respect of signal and/or data transmission, to a user operating device and/or a display device, in which case the user operating device and/or the display device and/or the memory device may appropriately be a remote device that is network-connected, in respect of signal and/or data transmission, to the controller.

The controller described above is advantageously configured and suitable for controlling the operation of the crimping device described at the beginning.

As mentioned above, the present disclosure also relates to a method for calibrating a crimping device, and to a method for controlling the operation of a crimping device, the two methods appropriately each using, for their proper execution, the controller described above. The two methods may be advantageously executed by use of a crimping device described at the beginning.

The method for calibrating a crimping device in this case appropriately includes the following two steps, namely step one and step two.

In step one, a suitable calibration of the crimping device is performed, appropriately including the above first and the third data being ascertained by the controller, such as when the crimping device is idling, from signals from the sensor system described above and from the formation of the likewise described control cam, and may appropriately also be checked by use of at least one suitable limit gauge. The information obtained from the exact transmission ratio i of the rotational speed of the rotor of the drive to the rotational speed of the gearing output, acting in combination with pressing elements the crimping device, of the gearing acting in combination with the drive, and from the known functional relationship of the angle of rotation of the drive and of the angle of rotation of the gearing output to the position of the pressing elements, such as during operation of the crimping device in idling mode, from the rest position, or zero position, of the pressing elements to the position of their maximum deflection, may in this case be appropriately checked and, if necessary, corrected by use of the at least one suitable limit gauge, or at least one suitable calibrating spike.

The ascertained first and third data are recorded on the memory device, together with further relevant data from the calibration of the crimping device, for their use in a method, described below, for controlling the operation of a crimping device. Step one is appropriately performed in the factory, following production of the crimping device, by the manufacturer of the crimping device.

In step two, step one is repeated when the crimping device is first put into operation and as required, an updated calibration being performed in each case, and the updated calibration being in each case compared with the original factory calibration and/or the last recorded calibration, and an ascertained deviation being recorded, together with the current calibration, on the memory device.

As mentioned above, the present disclosure relates to a method of controlling the operation of a crimping device by use of the controller described above, in which the method includes the following first, second, third and fourth steps and may further include the likewise following fifth, sixth and seventh steps.

In contrast to the step one and step two, described above, of the method for calibration, for reasons of clarity and conciseness the aforementioned steps of the method for controlling the operation of a crimping device are consistently referred to in the following as first step, second step, etc.

Performed in the first step of the method for controlling the operation of a crimping device is a hardware- and software-supported identification and/or an operator-performed identification of a contact sleeve intended for a crimping operation.

In the second step, ascertained from the second data are the parameters relevant for the controller for crimping of the contact sleeve, such as including the crimp height suitable for the contact sleeve and the outer diameter of the contact sleeve, for this purpose the data being compared with the identification performed in the first step.

In the second step, a second rest position, or first working position or insertion position, of the pressing elements for the contact sleeve may be advantageously provided in consideration of the ascertained outer diameter of the contact sleeve, such that a simple, secure and correct insertion of the contact sleeve to its proper position for execution of a crimping operation, as centrally as possible in the central crimping zone of the crimping device, is ensured.

This measure is particularly advantageous, such as for identifying a contact sleeve that may be too large and for ensuring simple and correct insertion and positioning of small contact sleeves.

In the third step, the crimping of the contact sleeve is performed using the parameters ascertained in the second step, a drive of the crimping device being controlled, such as in a pulsed manner, in such a way that pressing elements of the crimping device are brought from their rest position, or their zero position or from the second rest position, or first working position or insertion position, provided above in the second step, into a position that is in accordance with a crimp height corresponding to the contact sleeve.

In the fourth step, the drive of the crimping device is controlled in such a way that the pressing elements of the crimping device are returned to their rest position, or zero position or, in the case of a successive crimping of a multiplicity of similar contact sleeves, if necessary, also to the second rest position, or first working position or insertion position described above.

In the above third step, a position of the pressing elements that corresponds to the crimp height may be advantageously controlled dynamically, in that a first high rotational speed of the drive is continuously reduced in an appropriate manner until the position corresponding to the crimp height is reached at a rotational speed=0.

In the above third step, an angle of rotation of the rotor and/or an angle of rotation of the spike controller and a crimping force corresponding to the aforementioned angles of rotation may additionally be ascertained during the crimping operation. The force may be ascertained by a suitable sensor system and also from the motor current consumption of the motor.

Following the execution of the third and fourth steps, in the fifth step a comparison of the values ascertained in the third step with the first, second and third data is advantageously performed, with checking for conformity therewith, and with the result Yes or No.

In a sixth step, the contact sleeve is checked for its correspondence with the identification performed in the first step with the result Yes or No, the sixth step being performed in response to the result No in the fifth step. An angle of rotation of the spike controller corresponding to a first increase in the above crimping force and a corresponding position of the pressing elements may be checked for their correspondence with an outer diameter of the contact sleeve.

In a seventh step, the method is completed, the seventh step being performed in response to the result Yes of the fifth step.

If the result of the sixth step is No, at least the first, second, third, fourth and fifth steps are repeated. Otherwise, the seventh step is performed, and appropriately step two of the above method for calibrating a crimping device is performed.

The features of the crimping device and of the controller, as well as the steps of the two methods, have been described above in an abstract manner, and for a better understanding, such as of the features of the crimping device, reference is made here to the following description of an embodiment, which is accompanied by schematic drawings, and which relates to a 4-indent crimping device.

The crimping device, the controller and the two methods are suitable for reliable and, also efficient, successively performed, crimping of a multiplicity of, such as turned contact sleeves of different designs and/or functions, since the crimp height is not set mechanically but efficiently with hardware and software support, and since quality control and error correction are also made possible. The crimping device, the controller and the two methods are therefore suitable for crimping, such as the contacts of hybrid connectors.

### BRIEF DESCRIPTION OF THE SEVERAL VIEWS OF THE DRAWINGS

Embodiments of the present disclosure are represented in the drawings and explained in more detail in the following.

FIG. 1A shows a schematic representation of a crimping device.

FIG. 1B shows an enlarged spike of the crimping device of FIG. 1A.

FIG. 1C shows a cable and a contact sleeve, separate and crimped together.

FIG. 2A shows the crimping device of FIG. 1A from a different perspective.

FIG. 2B shows further examples of contact sleeves.

FIG. 3A shows a perspective representation of a spike carrier together with a spike controller of the crimping device of FIG. 1A.

FIG. 3B shows a perspective representation of a cam disc of the crimping device of FIG. 1A.

FIG. 4A shows a further schematic representation of the spikes of the crimping unit of FIG. 1A in a rest position, or zero position, together with a contact sleeve, properly arranged for crimping, and a cable.

FIG. 4B shows the spikes of FIG. 4A in a first position.

FIG. 4C shows the spikes of FIGS. 4a and 4B in a further position.

FIG. 4D shows the spikes of FIGS. 4A, 4B and 4C in a further position.

FIG. 5A shows a schematic representation to explain the operation of the crimping device by use of a suitable controller.

FIG. 5B shows a schematic flow diagram of a calibration method and of a method for crimping a cable to a contact sleeve.

### DETAILED DESCRIPTION

Some of the figures may contain simplified, schematic representations. In some cases, identical reference designations are used for elements that are alike but that may not be identical. Different views of the same elements may differ in scale. Not all reference designations are represented in all drawings.

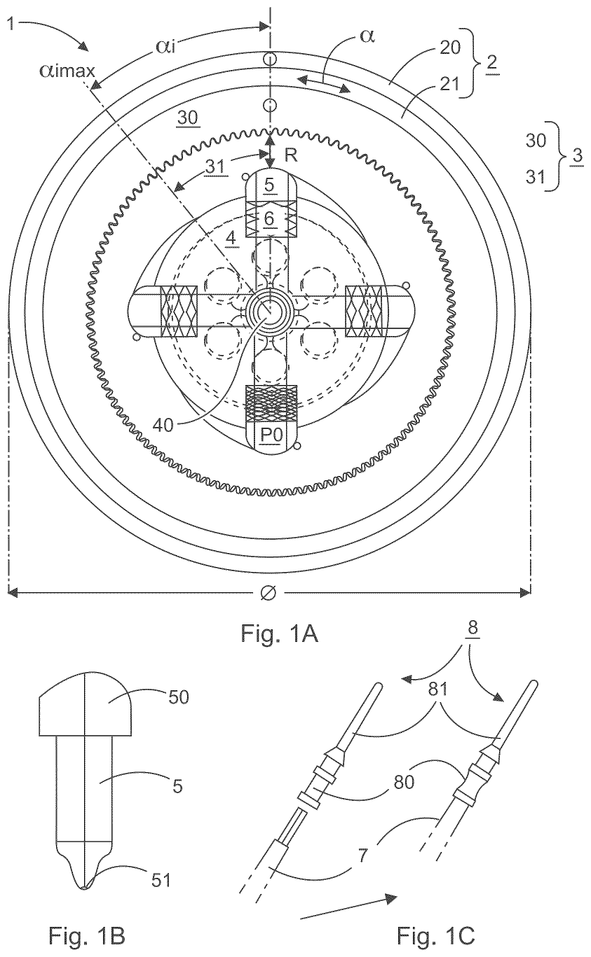

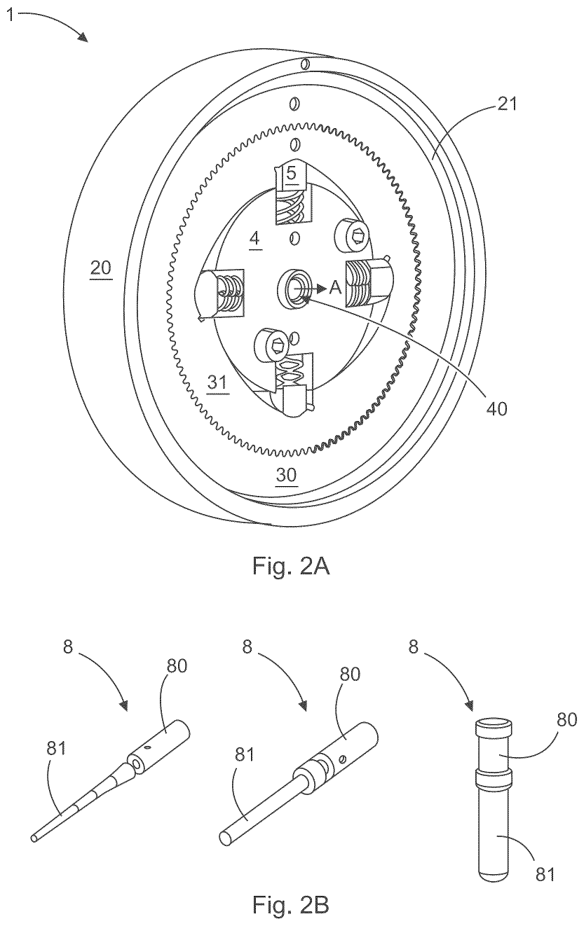

FIG. 1A shows a schematic representation of a crimping device 1 according to an embodiment of the present disclosure in a front view, FIG. 1B shows an enlarged spike 5 of the crimping device 1, and FIG. 1C shows a cable 7 with a contact sleeve 8, in each case separate and crimped together. The contact sleeve 8 is a turned contact sleeve 8 having a sleeve portion 80, for accommodating the strand of the stripped cable 7, and a contact portion 81. Further such contact sleeves 8 are represented schematically in FIG. 2B, the contact portion 81 of one of the contact sleeves 8 being realized, by way of example, as a signal transmission contact 81, while the contact sleeve 8 represented in the center and on the right of the drawing is realized as a first and second embodiment of a power contact 81.

The crimping device 1 is an indent crimping device 1, such as a four-spike crimping device, or 4-indent crimping device 1, the pressing elements 5 of which are realized as in the manner of spikes. The crimping device 1 has a spike carrier 4, which accommodates four pressing elements 5, realized as spikes 5, that are suitable for crimping a strand, or a conductor, of a stripped single-core cable 7 to a turned contact sleeve 8. The spike carrier 4 is represented semi-transparently in FIG. 1A, unlike in the perspective representation of the crimping device 1 of FIG. 2A, which shows its rear side.

The spike carrier 4 has a central crimping zone 40 that has a central axis A and, for each of the four spikes 5, the spike carrier 4 has a cylindrical guide in which the spikes 5 are mounted so as to be movable in a direction R, radially perpendicularly with respect to the central axis A. The spikes 5 have a central cylindrical portion, having a conically tapered tip 51 and a head 50, each of which acts in combination with a return spring 6 in such a way that the spikes 5 are pressed radially by the return springs 6 in the direction away from the central crimping zone 40.

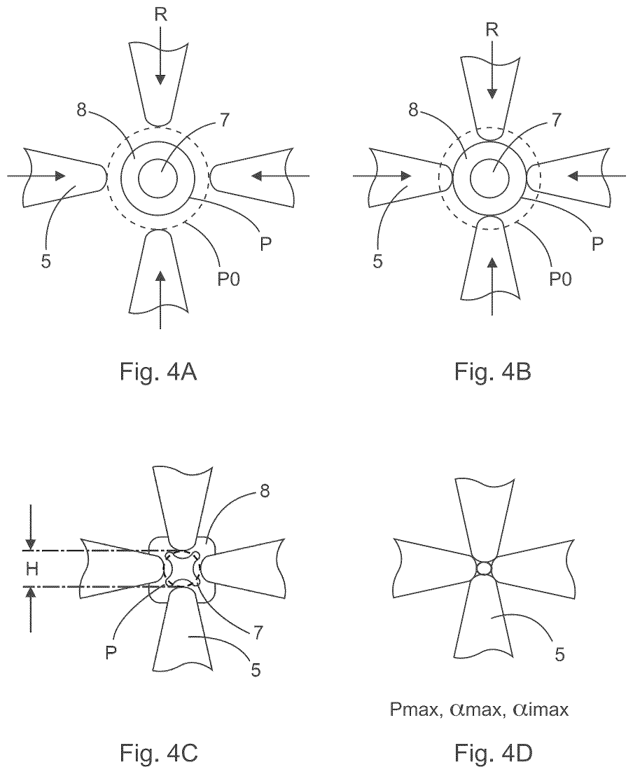

FIG. 4A shows a further schematic representation of the spikes 5 of the crimping device 1 of FIG. 1A in a rest position P0, or a zero position P0, without any deflection, together with a contact sleeve 8, properly arranged for crimping in the crimping zone 40 of the crimping device 1, and a cable 7. The tips 51 of the spikes 5 of the crimping device 1 are arranged concentrically with the contact sleeve 8, which is arranged centrally in the crimping zone 40.

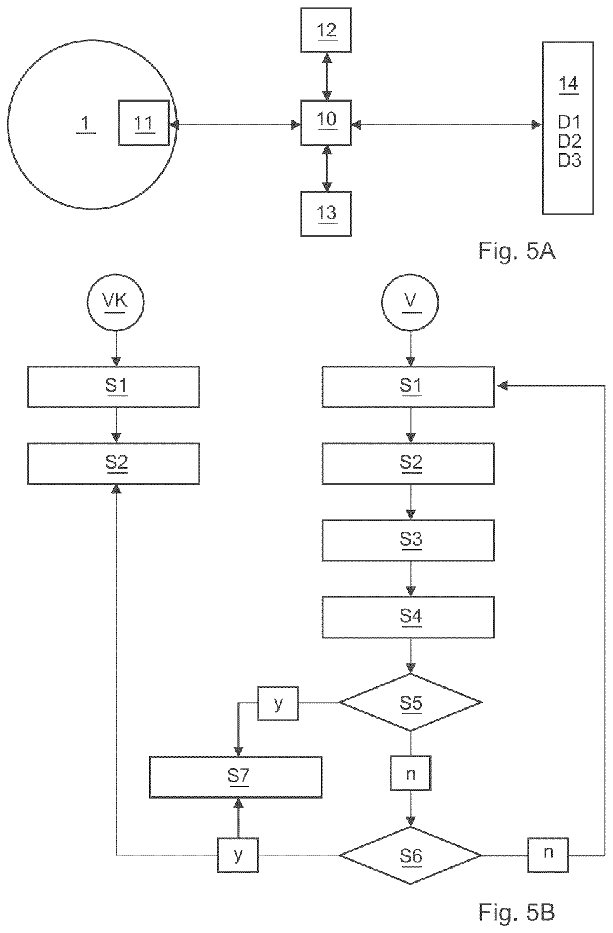

A displacement of the tips 51 of the spikes 5 from their rest position P0 to a position P is effected in this case against the force of the return springs 6 by use of a predefined torque M. In the first position P of FIG. 4B, the spikes 5 of the crimping device 1 are just touching the surface of the contact sleeve 8, and are thereby in a position P, which corresponds approximately to an outer diameter of the contact sleeve 8 and which, moreover, substantially corresponds to the position P described at the beginning and also described below with reference to FIG. 5B in connection with step S2 of method V, namely an advantageous second rest position P, or a first working position P, or an insertion position P of the pressing elements 5 to ensure simple and correct insertion and positioning of, in particular, small contact sleeves 8 in the central crimping zone 40.

FIG. 4C shows in this regard the spikes 5 of the crimping device 1 at position P, at which the tips 51 of the spikes 5 are arranged on a circle of a diameter H that corresponds to a predefined crimp height H. A minimum settable crimp height H corresponds to the position Pmax, in which the spikes 5 are maximally deflected from their rest position P0, and to the maximally settable angle of rotation αmax of the spike controller 31. Appropriately, the minimally settable crimp height H and the correspondingly maximally settable angle of rotation αmax may be set such that the tips 51 of the spikes 5 just touch each other. The spikes 5 of the crimping device 1 at their position Pmax are represented schematically in FIG. 4D. The setting of the crimp height H of the crimping device 1 is described below with reference to FIGS. 5A and 5B.

Provided as the drive 2 of the crimping device 1 is an electric motor 2, which is advantageously realized as a coreless motor 2, or frameless motor 2, and which appropriately acts in combination with a cycloidal gearing 3. Coreless motors 2 are characterized by a compact structural form and by a very high torque combined with a small structural size and allow a very dynamic and fast change of rotational speed.

The motor 2 has a stator 20 and a rotor 21 and is realized with its stator 20 substantially as a low-profile cylinder. The spike carrier 4 is arranged, with its crimping zone 40 and its central axis A, centrally within the cylindrical motor 2 and is surrounded by the gearing 3, which is arranged between the spike carrier 4 and the motor 2. For the proper use of the crimping device 1, suitable fastening elements such as, for example, threads and screws may be provided on the static spike carrier 4.

The gearing 3, which is advantageously realized as a cycloidal gearing 3, has a cam disc 30 having an inner cycloidal toothing 300, and has a spike controller 31 having an outer cycloidal toothing 311. An outer contour of the cam disc 30 is realized so as to correspond to an inner contour of the rotor 21, such that the cam disc 30 is driven by the rotating rotor 21 in such a way that it executes a wobbling rotary motion about the central axis A of the fixedly arranged spike carrier 4 and about the spike controller 31.

To provide the wobbling rotary motion of the cam disc 30 driven by the rotor 21, the cam disc 30 has an outer contour 301 corresponding to the inner contour of the rotor 21, as described above. In addition, for this purpose recesses 304 are provided on the cam disc 30, which act in combination with cylindrically realized pins 404 of the spike carrier 4 and which are realized and arranged so as to correspond to the pins 404.

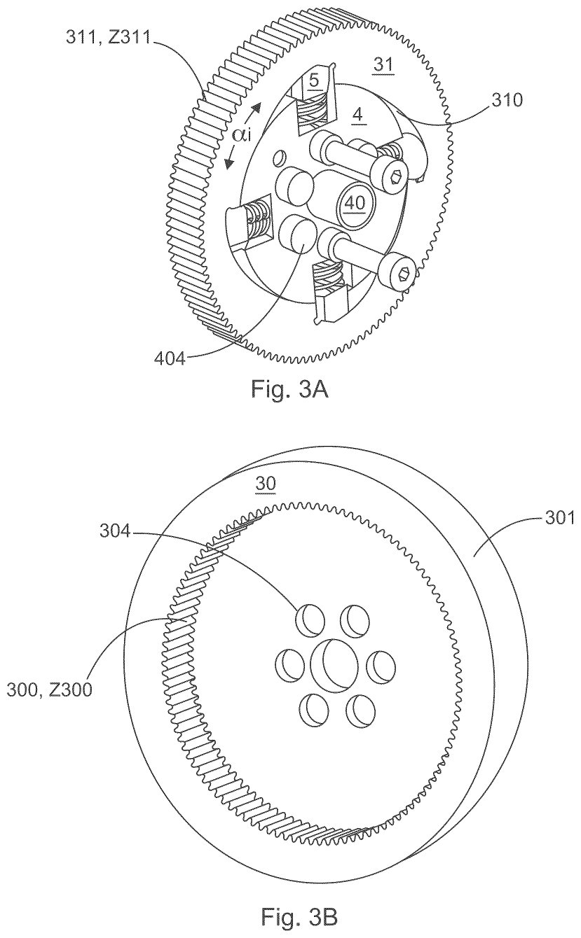

FIG. 3A shows in this regard a perspective representation of the spike carrier 4, which is surrounded by the spike controller 31 and has cylindrical pins 404 that, successively adjacent to one another, form a ring around the central crimping zone 40 and extend in the axial direction A. The cam disc 30, represented in perspective in FIG. 3B, viewed together on one drawing sheet with the spike carrier 4 and the spike controller 31 of FIG. 3A, has a central recess that corresponds to the central crimping zone 40 in such a way that the crimping zone 40 is freely accessible for its proper operation. The cam disc 30 additionally has recesses 304 that, successively adjacent to one another, form a ring around the central recess and are realized and arranged so as to correspond to the pins 404 in such a way that the wobbling rotary motion of the cam disc 30 around the central crimping zone 40, described above, is made possible.

For the purpose of providing the above rotary motion of the cam disc 30, there are at least three, and appropriately five, pins 404, and recesses 304, provided on the spike carrier 4 and the cam disc 30. The cam disc 30 in this case is additionally realized and arranged with its inner cycloidal toothing 300 corresponding to the outer cycloidal toothing 311 of the spike controller 31 in such a way that, with the above wobbling rotary motion of the cam disc 30, there is produced a rotation about a predefined angle of rotation ai of the spike controller 31, whereupon the spike control cam 310 realized on the inner contour 310 of the spike controller 31 properly acts in combination with the heads 50 of the spikes 5 and sets their radial R positioning, and the position P of their tips 51.

A crimping device 1 described above, with its drive 2, gearing 3 and spike carrier 4, and their advantageous joint arrangement around a central crimping zone 40, is of a particularly compact design and advantageously suitable for many applications, both in stationary industrial operation and in a mobile hand-held tool. Moreover, the crimping device 1 is also of an advantageously low weight.

The crimping device 1 may appropriately have a diameter ø of from 80 mm to 100 mm, and advantageously from 60 mm to 80 mm, and in some embodiments in the range of 50 mm to 60 mm.

In one embodiment represented in the drawings, for reasons of clarity and conciseness, and to aid understanding, a maximum angle of rotation αimax of the spike control cam 31 is approximately 20°, although the maximum angle of rotation αimax of a 4-indent crimping device 1 is naturally limited due to the dimensions of the spikes 5, and is accordingly less than 90°, and may also advantageously be in particular approximately 60° to enable advantageous recalibration.

In accordance with their diameter ø of the above advantageous dimensions, the motor 2 with the inner contour of its rotor 21, the gearing 3 with the outer contour 301 of its cam disc 30, the inner contour 310 of the spike controller 31, as well as their inner 300 and outer 311 cycloidal toothing, respectively, may be designed in such a way that, as described at the beginning, a transmission ratio i of the rotational speed of the drive 2 to the rotational speed of the spike controller 31, for providing a maximum angle of rotation αimax of the spike control cam 31, desirable for a 4-indent crimping device 1, lies in the range of from approximately 20° to approximately 60°, appropriately in a range i of from 50 to 1,000, and advantageously in a range of from 60 to 600 and, for the application of the crimping device 1 in a mobile hand-held tool, advantageously in the range of approximately i=100.

The transmission ratio i, namely i=rotational speed of the rotor 21/rotational speed of the spike control cam 31, corresponds to the design of the cycloidal gearing 3, namely the ratio of a number of teeth Z311 of the cycloidal gearing 311 to the difference of a number of teeth Z300 of the cycloidal gearing 300 and a number of teeth of the cycloidal gearing 311, and is thus given by the equation i=Z311/(Z300−Z311).

Since only whole numbers of teeth are technically feasible, the above advantageous transmission ratio of i=100, for example the number Z311 of 100 teeth of the cycloidal gearing 311 and the number Z300 of 101 teeth of the cycloidal gearing 300, are therefore possible for a corresponding design of the cycloidal gearing 3.

Assuming a linearly decreasing control-cam contour 310, there is obtained, for example, the relationship of A50(αimax)=−1/15*αimax+22, where A50(αimax) is the distance between the central axis A of the crimping center 40 and the contact point of the head 50 of a spike 5 on the spike control cam 310.

The position Pmax of the spike tip 51 relative to the central axis A of the crimping center 40 corresponds, as described above with reference to FIGS. 4A to 4D, to the minimum crimp height H, resulting in the following equation, namely

$$P max = P ( α i max ) = A 50 ( α i max ) - L 5 ,$$

where L5 corresponds to the length of the crimping spike 5.

This ultimately yields the relationship between the position P of the tip 51 of a crimping spike 4 and the angle of rotation α of the drive motor 2, namely Pmax=P(αmax)=−1/15*αmax*100+22. The position P, namely the distance between the tip 51 of a spike 5 and the central axis A of the crimping center 50, also corresponds to half the crimp height H, namely P=H/2, as also described above with reference to FIGS. 4A to 4D.

The above design of the transmission ratio i of approximately 100 permits a precisely controllable angle of rotation α with a correspondingly precisely controllable positioning P of the spikes 5, and thus permits advantageously precise controlling of a predefined crimp height H. Moreover, an above advantageous reduction ratio of i=100 enables an advantageous corresponding increase in the output torque M, to approximately 200 Nm, and thus a desirable operation of the crimping device 1 with the coreless motor 2 as a drive, which, as mentioned above, has a desirably high torque combined with a small size, and permits a desirably dynamic and fast change of rotational speed.

The crimping device 1, which above is realized, as an example and advantageously, as a 4-indent crimping device, may also be realized in some embodiments as a 2-indent crimping device 1 or 8-indent crimping device 1. Instead of an indent crimping device 1 having a spike carrier 4 and the spikes 5, suitable jaw tongs may also be provided to realize the pressing elements 5, which may likewise be driven by a coreless motor 2 and a cycloidal gearing 3, as may be desirable for selected applications.

FIG. 5A shows a schematic representation to explain the operation of the crimping device 1 using a suitable controller 10, and FIG. 5B shows a schematic flow diagram of a method VK for calibrating a crimping device 1, and a method V for crimping a cable 7 to a contact sleeve 8.

To enable the crimping device 1 to be operated in desirably simple and efficient manner, the crimping device 1 may be controlled by a suitable hardware- and software-supported controller 10, and the crimping device 1 may have a suitable sensor system 11 comprising sensors for angle measurement and/or torque measurement and/or force measurement and/or identification.

At least one Hall sensor, as an example, that is suitable for displacement measurement and thus for angle determination, and as a displacement sensor, may appropriately be provided at at least one suitable position of the motor 2 for the purpose of sensing the rotation of its rotor 21, and/or at at least one suitable position of the spike carrier 4 for the purpose of sensing the angle of rotation αi of the spike controller 31.

In addition, at least one strain gauge that is suitable for force measurement, and as a force sensor, may appropriately be provided at at least one suitable position on the inner contour 310 of the spike controller 31, which in a crimping operation acts in combination with the head 50 of the spike 5, the at least one force sensor sensing the substantially constant restoring force of the spring 6 acting upon the head 50 of the spike 5, and thus upon the spike control cam 310, when the crimping device 1 is idling.

The controller 10 is also appropriately configured in respect of hardware and software, such as for controlling the motor 2 and for sensing and analysing the signals from the sensor system 11, as well as for sensing the motor current consumption. In addition, the controller 10 may be appropriately connected, in respect of signal and/or data transmission, to a suitable user operating device 12 and/or a suitable display device 13 and/or memory device 14. The memory device 14 may be a remote memory device 14, which is network-connected, in respect of signal and/or data transmission, to the controller 10.

First data D1 for controlling the crimping device 1 may advantageously be stored in a retrievable manner on the memory device 14 in order to control a suitable drive of the crimping device 1. The first data D1 appropriately comprise the exact transmission ratio i of the rotational speed of a rotor 21 of the drive 2 to a rotational speed of the gearing output, acting in combination with pressing elements 5 of the crimping device 1, of the gearing 3 acting in combination with the drive 2, and the functional relationship of the angle of rotation α of the drive 2 and of the angle of rotation αi of the gearing output to a force acting upon the pressing elements 5, as well as to the position P of the pressing elements 5, such as during operation of the crimping device 1 in idling mode, from the rest position P0 of the pressing elements 5 to the position Pmax of their maximum deflection.

In addition, the memory device 14 may advantageously have available second data D2 of the individual properties of a multiplicity of different contact sleeves 8, such as for the setting of the crimp height H suitable for a predefined individual contact sleeve 8 and its predefined use. In addition to the type of contact sleeve 8, its proper use, its individual article designation, also, for the purpose of machine identification, the serial number and/or alpha-numeric coding assigned to the contact sleeve 8, etc., the second data D2 may advantageously comprise technical data D2, such as the material, dimensions, i.e., the outer and inner diameter of the contact sleeve 8, as well as the individual crimp height H suitable for crimping the contact sleeve 8 to a conductor of a predefined cable 7.

The above second data D2 including an individual optimum crimp height H may appropriately be ascertained by the manufacturer of the contact sleeve 8 by appropriate series of tests using the crimping device 1 that is also of identical structural design. The second data D2 may be routinely maintained and also updated by the manufacturer, and the second data D2 may appropriately be made available by the manufacturer via a network for use by the controller 10 of the crimping device 1.

In addition, the memory device may advantageously have available for the controller 10 third data D3, which indicate the functional relationship of the provided force and/or torque M to the rotational speed and/or the angle of rotation α of the rotor 21 and/or to the angle of rotation αi of the spike controller 31, such as when the crimping device 1 is idling, from the first rest position P0 of the spikes 5 and the spike controller 31 up to their maximum deflection, or rotation αimax. The third data D3 likewise appropriately originate initially from a first calibration of the crimping device 1 and may be checked during routine idling measurements and, if necessary, updated by use of limit gauges.

By use of the first D1 and third data D3, the controller 10 may also advantageously detect and quantify a drift, such as of the mechanical properties of the crimping device 1, for example due to attrition, at the tips 51 of the spikes 5 or of the cycloidal teeth 300 and 311, and likewise store, or update, this appropriately on the memory device 14, together with the third data D3.

The above quantified drift may also appropriately be taken into consideration in the method VK for calibrating a crimping device 1 and method V for controlling the operation of a crimping device 1, which are described below.

As described above, the controller 10 is appropriately configured to set the crimp height H in the crimping of a contact sleeve 8 to a conductor of a cable 7 by regulating the rotational speed of the drive 2 corresponding to the crimp height H in accordance with the first D1 and second D2 data.

The method VK for calibrating a crimping device 1 is appropriately performed using the controller 10 described above.

In a first step S1 of the method VK for calibration, a calibration of the crimping device 1 is first appropriately performed, including, ascertainment of the first data D1 and third data D3 as described at the beginning, such as by at least one limit gauge, and then a record is made of the first data D1 and third data D3 together with further relevant data of the calibration of the crimping device 1, such as, for example, location, date, ID of the crimping device 1, etc., on the memory device 14. Appropriately, step S1 is performed at the factory following production of the crimping device 1.

In a second step S2, step S1 is repeated when the crimping device 1 is first put into operation and as required, an updated calibration being performed in each case, and the updated calibration being appropriately compared with the original factory calibration and/or the last recorded calibration, and an ascertained deviation being recorded together with the current calibration.

As with the method VK, the method V for controlling the operation of the crimping device 1 is also performed by use of the controller 10.

In a first step S1 of the method V, a hardware- and software-supported identification and/or an operator-performed identification of a contact sleeve 8 intended for a crimping operation is performed.

Following the first step S1, in a second step S2, ascertained from the second data D2 and from the identification ascertained in the first step S1 are the parameters relevant for the controller 10 for crimping of the contact sleeve 8, including the crimp height H suitable for the contact sleeve 8 and the outer diameter of the contact sleeve 8.

In the second step S2, a second rest position P, or first working position P or insertion position P, of the pressing elements 5, which corresponds to a distance of the tips 51 of the pressing elements 5 that is slightly greater than the outer diameter of the contact sleeve 8, may be advantageously provided in consideration of the outer diameter of the contact sleeve 8, such that a simple, secure and correct insertion of the contact sleeve 8 to its proper position for executing a crimping operation, as centrally as possible in the central crimping zone 40 of the crimping device 1, is ensured. This measure, as described at the beginning, is advantageous for early identification of a contact sleeve 8 that may be too large and for ensuring simple and correct insertion and positioning of small contact sleeves 8.

In a third step S3, the crimping of the contact sleeve 8 is performed using the parameters ascertained in step S2, a drive 2 of the crimping device 1 being appropriately controlled, such as in a pulsed manner, in such a way that pressing elements 5 of the crimping device 1 are brought from their rest position P0, or zero position, or from their second rest position P, or first working position P or insertion position P, provided above in step S2, into a position P that is in accordance with a crimp height H corresponding to the contact sleeve 8.

In a succeeding final step S4, the drive 2 of the crimping device 1 is controlled in such a way that the pressing elements 5 of the crimping device 1 are returned to their rest position P0, or zero position P0, or firstly to the second rest position P, or first working position P or insertion position P.

In the case of the method V for controlling the operation of a crimping device 1, in the third step S3 a position P of the pressing elements 5 that corresponds to the crimp height H may be advantageously dynamically controlled, such as that a first high rotational speed of the drive 2 is continuously reduced in an manner until the position P is reached at a rotational speed=0, while in the third step S3, during the crimping operation, an angle of rotation α and/or an angle of rotation αi and a force corresponding to the angle of rotation α and/or to the angle of rotation αi may also be ascertained.

In a fifth step S5 of the method V, a comparison of the values ascertained in the third step S3 with the first D1, second D2 and third D3 data, and a check for correspondence therewith, and with the result Yes or No y/n, may be appropriately performed.

In a sixth step S6, a check of the contact sleeve 8 for conformity with the identification performed in the first step S1 with the result Yes or No y/n may be performed, the sixth step S6 being performed under the condition that the result of the comparison in the fifth step S5 is No n.

Finally, the method V may be terminated in a seventh step S7 on the condition that the result of the comparison in the fifth step S5 is Yes y.

Provided that the result of the check in the sixth step S6 is No n, at least the above steps S1 to S5 are repeated, and if, on the other hand, the result of the check in the sixth step S6 is Yes y, the method is terminated in the seventh step S7, and the second step S2 of the method VK described above and an advantageous recalibration are additionally performed.

Even if various aspects or features of the disclosure are shown in combination in the figures, it is apparent to a person skilled in the art—unless otherwise stated—that the combinations represented and discussed are not the only possible combinations. In particular, mutually corresponding units or sets of features from different exemplary embodiments may be interchanged.

German patent application no. 10 2023 128 920.9 filed Oct. 20, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A crimping device for crimping a conductor of a predefined cable to a predefined contact sleeve, the crimping device comprising:
at least two pressing elements that are mounted so as to be reversibly movable relative to a central crimping zone of the crimping device to provide a crimp of a predefined crimp height;
a drive configured for operation of the pressing elements; and a mechanism that operatively connects the drive to the pressing elements,
wherein the drive is an electrically driven, substantially low-profile cylindrical coreless motor, and
wherein the pressing elements and the mechanism are arranged within the cylindrical motor.

2. The crimping device according to claim 1, wherein the mechanism is a cycloidal gearing and is operatively connected to the motor and the pressing elements; and
the central crimping zone and the pressing elements are arranged within the cycloidal gearing.

3. The crimping device according to claim 2, wherein
the motor has a stator and a rotor;
the cycloidal gearing has a cam disc and a spike controller, which are adjacent to each other and act in combination mechanically;
the cam disc has an outer contour arranged to correspond to an inner contour of a rotor in such a way that a predefined rotation of the rotor can be transmitted to the cam disc;
the cam disc has an inner contour having a cycloidal toothing;
the spike controller has an outer contour, having cycloidal toothing, which is arranged to correspond to the inner contour of the cam disc in such a way that a predefined rotation of the cam disc can be transmitted to the spike controller; and
the spike controller has an inner contour realized as a control cam of the pressing elements, which is arranged in such a way that a rotation of the spike controller by a predefined angle produces a predefined position of the pressing elements.

4. The crimping device according to claim 1, wherein the mechanism is configured to produce a predefined transmission ratio i, of a rotational speed of the motor to the spike controller operatively connected to the pressing elements, that is much greater than 1, such that the mechanism generates a predefined reduction ratio i.

5. The crimping device according to claim 4, wherein
the reduction ratio i is in a range of from 50 to 1,000.

6. The crimping device according to claim 4, wherein the reduction ratio i is lying in a range of from 60 to 600.

7. The crimping device according to claim 4, wherein the reduction ratio i is in the range of approximately i=100.

8. The crimping device according to claim 1,
wherein the crimping device is configured such that an output torque is provided in a range of from 100 Nm to 400 Nm.

9. The crimping device according to claim 1, wherein the crimping device is configured such that an output torque is provided in a range of approximately 200 Nm.

10. The crimping device according to claim 1, wherein the cylindrical coreless motor has an outer diameter in a range of from 80 mm to 100 mm.

11. The crimping device according to claim 1, wherein the cylindrical coreless motor has the outer diameter in a range of from 60 mm to 80 mm.

12. The crimping device according to claim 1, wherein the cylindrical coreless motor has the outer diameter in a range of from 50 mm to 60 mm.

13. The crimping device according to claim 3, wherein the control cam of the spike controller is arranged in such a way that a recalibration of the crimping device is rendered possible, including in particular in the case of attrition of the mechanism and/or of the pressing elements.

14. The crimping device according to claim 3, wherein the crimping device is a 4-indent crimping device having pressing elements in the form of spikes,
wherein the pressing elements are guided, radially perpendicularly with respect to a central axis of the central crimping zone, in a spike carrier arranged centrally within the motor, and
wherein the cycloidal gearing of the 4-indent crimping device is configured such that a rotation of the spike controller by an angle of at least 20° causes a maximum deflection of the pressing elements from a rest position into a position of maximum deflection.

15. The crimping device according to claim 3, wherein the cycloidal gearing of the 4-indent crimping device is configured such that a rotation of the spike controller is by an angle of approximately 60°.

16. The crimping device according to claim 4, wherein the crimping device has a sensor system configured to operate the crimping device by a hardware- and software-supported controller, which comprises at least one sensor for angle measurement and/or torque measurement and/or force measurement and/or identification of a contact sleeve, and
wherein the controller is configured to regulate the rotational speed of the motor in accordance with the crimp height.

17. The crimping device according to claim 1, wherein the motor is a stepper motor or a servo motor.

18. A hardware- and software-supported controller configured to operate a crimping device, having an electric drive and a transmission ratio i of much greater than 1, wherein:
the controller is connected, in respect of signal and/or data transmission, to a suitable user operating device and/or display device and/or memory device;
first data, second data and third data is available on the memory device for the controller of the crimping device;
the first data comprises the transmission ratio i of a rotational speed of a rotor of the electric drive to a rotational speed of a gearing output, acting in combination with pressing elements of the crimping device, of a gearing acting in combination with the electric drive, and a functional relationship of an angle of rotation of the electric drive and of an angle of rotation of the gearing output to a force acting upon on the pressing elements, as well as to a position of the pressing elements from a rest position of the pressing elements up to a position of maximum deflection;
the second data comprises, for a crimping of a contact sleeve to a conductor of a cable, data configured to identify the contact sleeve, and technical properties and characteristics of in each case a multiplicity of different contact sleeves and in each case an outer diameter and a crimp height of an individual contact sleeve suitable for the crimping;
wherein the third data comprises the functional relationship of the angle of rotation of the electric drive and of the angle of rotation to a force acting upon the pressing elements during operation of the crimping device in idling mode, from the rest position of the pressing elements up to the position of maximum deflection; and
the controller is configured, in crimping of a contact sleeve to a conductor of a cable, to set the crimp height by regulating the rotational speed of the electric drive corresponding to the crimp height, in accordance with the first and the second data.

19. The controller according to claim 18, wherein, for the purpose of controlling and monitoring the operation of the crimping device, the controller is connected, in respect of signal and/or data transmission, to a sensor system of the crimping device that comprises at least one sensor for angle measurement and/or torque measurement and/or force measurement and/or identification of the contact sleeve.

20. The controller according to claim 18,
wherein the user operating device and/or the display device and/or the memory device is a remote device that is network-connected, in respect of signal and/or data transmission, to the controller.

21. The controller according to claim 18, wherein the controller is configured for operating a crimping device according to claim 1.

22. A method for calibrating a crimping device by use of a controller having: an user operating device and/or display device and/or memory device connected to the controller in respect of signal and/or data transmission; first data, second data and third data being available on the memory device for the controller of the crimping device, the method comprising:
performing a calibration of the crimping device, including ascertaining the first data and third data and recording, the first data and third data on the memory device wherein performing the calibration can be performed by use of at least one limit gauge, and following production of the crimping device, in a factory to define an original factory calibration;
repeating performing the calibration when the crimping device is first put into operation and as required, to generate an updated calibration, and the updated calibration being in each case compared with the original factory calibration and/or a last recorded calibration, and
an ascertained deviation being recorded, together with the current calibration, on the memory device.

23. A method for controlling an operation of a crimping device by use of a controller having: a user operating device and/or display device and/or memory device connected to the controller in respect of signal and/or data transmission; first data, second data and third data being available on the memory device for the controller of the crimpling device, the method comprising:
identifying, via hardware- and software-supported identification and/or an operator-performed identification, a contact sleeve intended for a crimping operation;
ascertaining from the second data parameters relevant for the controller for crimping of the contact sleeve, including a crimp height for the contact sleeve and an outer diameter of the contact sleeve, and positioning the contact sleeve, in a central crimping zone of the crimping device, at a proper position of the crimping device for execution of the crimping operation,
bringing the pressing elements out of a rest position, or a zero position, into a first working position, or an insertion position;
performing the crimping of the contact sleeve using the parameters ascertained, a drive of the crimping device being controlled in such a way that pressing elements of the crimping device are brought from the rest position, or zero position, or the first working position, or the insertion position, into a crimp position that is in accordance with the crimp height corresponding to the contact sleeve; and
controlling the drive of the crimping device in such a way that the pressing elements of the crimping device are returned to the rest position, or zero position, or to the first working position, or the insertion position.

24. The method according to claim 23,
wherein during performing the crimping of the contact sleeve, a position of the pressing elements that corresponds to the crimp height is controlled dynamically, in that a first high rotational speed of the drive is continuously reduced in a manner until the first position is reached at a rotational speed=0;
wherein during performing the crimping of the contact sleeve, an angle of rotation and/or an angle of rotation and a force corresponding to the angle of rotation and/or to the angle of rotation is additionally ascertained during the crimping operation; and
further comprising:
performing a comparison of the values measured during performing the crimping with the first data, second data and third data, with checking for conformity therewith, and with a result Yes/No;
checking of the contact sleeve for conformity with the identification performed, with the result Yes/No;
terminating the method;
with:
terminating being performed in response to the result Yes during performing the comparison of the values measured;
checking of the contact sleeve for conformity with the identification performed being performed in response to the result No when performing the comparison of the values measured;
in response to the result No when checking of the contact sleeve for conformity with the identification performed, repeating the method at least up to performing the comparison of the values measured; and
in response of the result Yes when checking of the contact sleeve for conformity with the identification performed, terminating the method, and additionally repeating a calibration.

25. The method according to claim 23, wherein during performing the crimping of the contact sleeve, the drive is controlled and performed in a pulsed manner, and the force corresponding to the angle of rotation and/or to the angle of rotation is ascertained from a motor current consumption of a motor of the drive.
